(19) United States
(12) Patent Application Publication
(10) Pub. No.: US 2009/0037951 A1
(43) Pub. Date: Feb. 5, 2009

(54) Identification of Streaming Content Playback Location Based on Tracking RC Commands

(75) Inventors: Brant Candelore, San Diego, CA (US); Chris Read, San Diego, CA (US); Robert Hardacker, Escondido, CA (US)

Correspondence Address: BLAKELY SOKOLOFF TAYLOR & ZAFMAN LLP, 1279 OAKMEAD PARKWAY, SUNNYVALE, CA, 94085-4040, US

(73) Assignees: SONY CORPORATION, Tokyo (JP); SONY ELECTRONICS, INC., Park Ridge, NJ (US)

(21) Appl. No.: 11/831,789

(22) Filed: Jul. 31, 2007

(51) Int. Cl. H04N 5/445

(52) U.S. Cl. 725/37

(57) ABSTRACT

Apparatus for identifying a playback position in a audiovisual content stream received from an audiovisual content source includes an audiovisual content display that displays the audiovisual content stream to a user. A command receiver receives remote control commands directed to the audiovisual content source. A playback position identifier estimates the playback position in the audiovisual content stream by analyzing the remote control commands for the audiovisual content source. A presentation unit presents additional information related to the playback position to the user.

### BACKGROUND

Audiovisual content streams may be received from a variety of devices for display or storage by various types of audiovisual content display apparatus. It may be desirable to display information about or related to the received audiovisual content stream. However, the display device may receive the audiovisual content stream as compressed or decompressed content without any metadata that provides information about the content such as the playback position within the content.

An example of such content delivery would be the delivery of content to a television monitor by a cable set top box. The cable set top box may provide the audiovisual content stream to the television monitor via an analog or digital signal connection that provides for the delivery of content but not associated identifying data. As the cable set top box may handle interaction with the viewer to select the content, the television monitor may be completely deprived of any information about the content being displayed.

Even if the television monitor does have the title of the audiovisual content, it may not have any information about the location of where in the content playback is occurring from or the speed at which it is occurring. This information can be important for generating its own on-screen displays to the user, e.g. time remaining. The information can also be used in association with a time-based content database to learn what is happening on screen or in the audio. Knowing what is happening on screen or in the audio can allow the monitor to provide additional contextual information to viewer.

It would be useful to provide an apparatus and a method that allows a receiving device to identify a playback position within an audiovisual content stream.

### SUMMARY

Apparatus for identifying a playback position in an audiovisual content stream received from an audiovisual content source includes an audiovisual content display that displays the audiovisual content stream to a user. A command receiver receives remote control commands directed to the audiovisual content source. A playback position identifier estimates the playback position in the audiovisual content stream by analyzing the remote control commands for the audiovisual content source. A presentation unit presents additional information related to the playback position to the user.

Other features and advantages of the present invention will be apparent from the accompanying drawings and from the detailed description that follows below.

### BRIEF DESCRIPTION OF THE DRAWINGS

The present invention is illustrated by way of example and not limitation in the figures of the accompanying drawings, in which like references indicate similar elements and in which:

FIG. 1 is a system that embodies the invention.

FIG. 2 is a block diagram of the system of FIG. 1.

FIG. 3 is another display format that may be used by the system of FIG. 1.

FIG. 4 is yet another display format that may be used by the system of FIG. 1.

FIG. 5 is a block diagram of another system that embodies the invention.

FIG. 6 is yet another system that embodies the invention.

FIG. 7 is a flowchart of a method that embodies the invention.

FIG. 8 is a flowchart of another method that embodies the invention.

FIG. 9 is a flowchart of another method that embodies the invention.

FIG. 10 is a flowchart of another method that embodies the invention.

### DETAILED DESCRIPTION

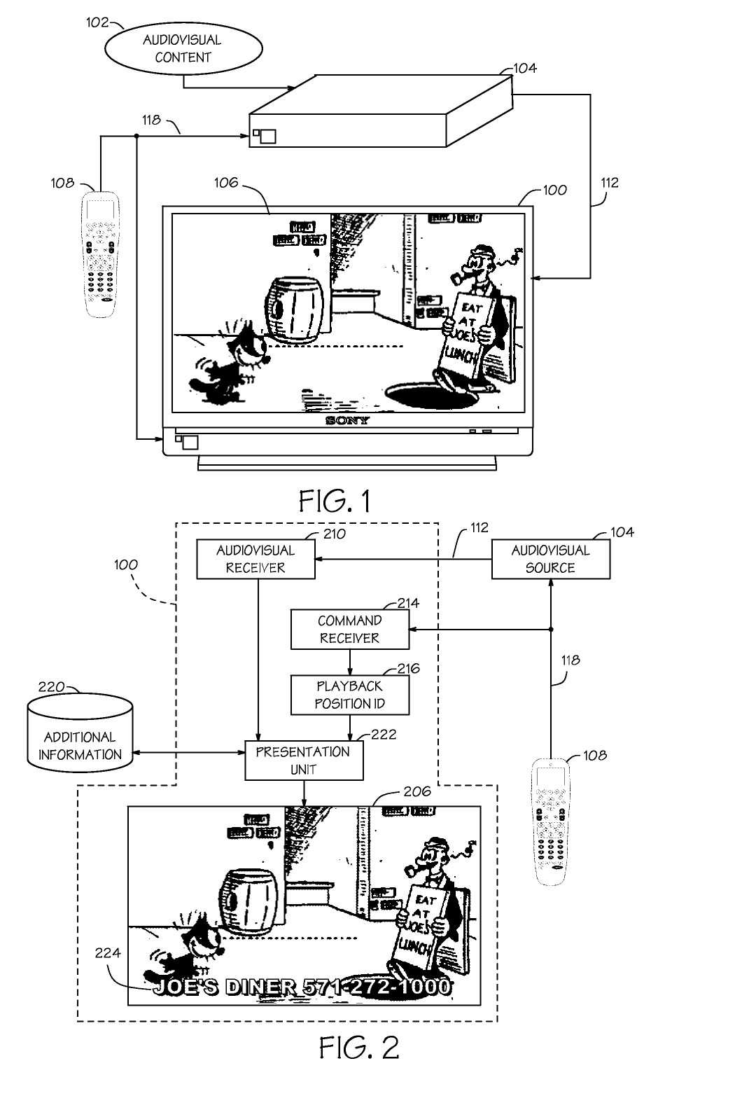

FIG. 1 shows a system that includes an audiovisual content display apparatus 100, a television in this example, that embodies the invention. An audiovisual content source 104 receives audiovisual content 102 and provides it to the audiovisual content display apparatus 100 as an audiovisual content stream. The audiovisual content display apparatus 100 displays the audiovisual content stream to a user. For example, the audiovisual content display apparatus 100 may display the audiovisual content stream on a screen 106. The audiovisual content display apparatus 100 may also present an audio accompaniment that may be included with the audiovisual content 102.

The audiovisual content source 104 may be any of a variety of devices such as, but not limited to, a cable set-top box, a satellite receiver, an IPTV receiver, a digital versatile disk (DVD) player, a Blu-ray Disc player, an HD DVD player, or a digital video recorder that are separate from the audiovisual content display apparatus 100. The audiovisual content 102 may be provided in a variety of forms such as broadcast television programming, DVD discs, or a hard disk recording. A remote control 108 allows the user to control the operation of the audiovisual content source 104 device.

FIG. 2 shows a block diagram of the audiovisual content display apparatus 100. An audiovisual content receiver 210 receives the audiovisual content stream 112 from the audiovisual content source 104. The audiovisual content display 206 displays the audiovisual content stream 112 to the user.

A command receiver 214 receives remote control commands 118 that are directed to the audiovisual content source 104. It will be appreciated that the remote control commands 118 directed to the audiovisual content source 104 are not intended for the audiovisual content display apparatus 100. The audiovisual content display apparatus is “eavesdropping” on the remote control commands 118 intended for the audiovisual content source 104. The command receiver 214 may be configurable so that the remote control commands 118 for the audiovisual content source 104 may be recognized by the audiovisual content display apparatus 100.

A playback position identifier 216 receives the decoded remote control commands 118 from the playback position identifier 216. The playback position identifier 216 estimates a playback position in the audiovisual content stream 112 by analyzing the remote control commands 118 intended for the audiovisual content source 104. The audiovisual content source may provide various playback options such as pause, fast forward, slow motion, and reverse that cause the playback position in the audiovisual content stream 112 to change at various rates.

The playback position identifier 216 may be configured with the rate of change in playback position for the audiovisual content source 104 when the various remote control commands 118 are sent to the audiovisual content source. For some audiovisual content sources 104, the rate of change in playback position set by a remote control command 118 may depend on the current rate of change in playback position. For example, a fast forward (FF) command may set the rate of change to twice real-time (2×) if the rate of change is currently real-time, as it would be if the audiovisual content source is in play mode. A second FF command may set the rate of change to five times real-time (5×). The playback position identifier 216 may be configured to track such state sensitive changes in playback rates.

A presentation unit 222 receives the estimated playback position from the playback position identifier 216. The presentation unit 222 presents the user with additional information 220 related to the playback position. The additional information 220 may be obtained from a variety of sources such as, but not limited to, a local data store or a network accessible source of additional information. The additional information 220 may be provided to the apparatus by any of a variety of means such as interleaved with the audiovisual content or by a separate network connection to a data provider which may be continuously or intermittently connected. The network connection may be shared with the connection that delivers the audiovisual content or may be an independent network connection such as an internet connection.

The presentation unit 222 may also receive an identification of the audiovisual content stream 112 from a portion of the audiovisual content display apparatus 100 not shown. For example, the remote control commands 118 may be analyzed by additional devices to determine the identity of the audiovisual content stream 112. In other systems, various characteristics of the audiovisual content stream 112 may be analyzed to identify the audiovisual content stream 112. The presentation unit 222 may use the identity of the audiovisual content stream 112 along with the estimated playback position from the playback position identifier 216 to select or obtain additional information 220 for presentation to the user.

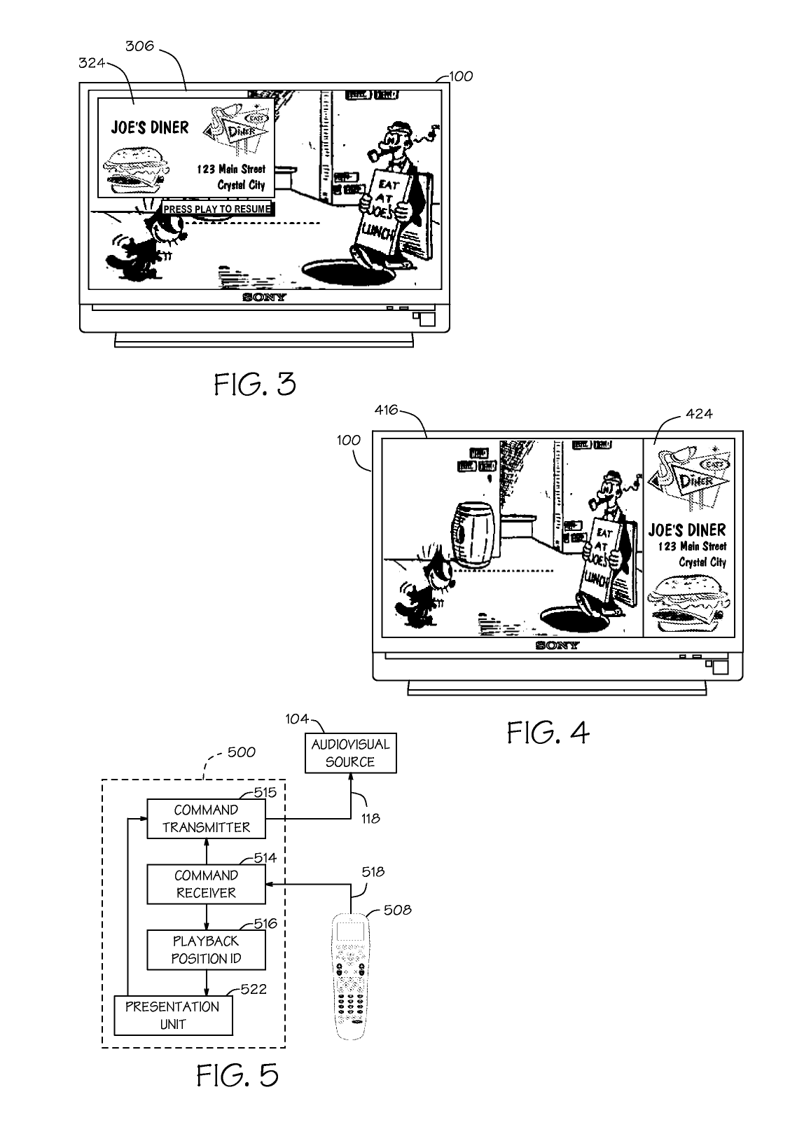

The presentation unit 222 may receive the output of the audiovisual content receiver 210 and mix the additional information 220 with the output. The additional information may be presented to the user on the audiovisual content display 206 in any of a variety of formats such as, but not limited to, an audiovisual content overlay 224 as shown in FIG. 2, a picture-in-picture (PIP) display 324 as shown in FIG. 3, or a picture outside picture (POP) display 424 as shown in FIG. 4.

The additional information presented to the user may be saved for later viewing. The additional information may be saved in the form of short descriptive phrases or links that allow the complete additional information to be retrieved for presentation by selection of the link, which may be presented in a list of links. The user may be presented with an offer to save a link, which is saved if the user so chooses. Offering to save a link may be done as an alternative to pausing the display of the audiovisual content or when the audiovisual content cannot be paused. Saved links may be kept until deleted or they may be deleted automatically after being viewed or after some time has elapsed since they were saved.

FIG. 5 shows a block diagram of another audiovisual content display apparatus 500. For clarity the audiovisual content receiver and audiovisual content display portions of the audiovisual content display apparatus 500 are not shown. The audiovisual content display apparatus shown includes a command transmitter 515 to transmit remote control commands 118 to the audiovisual content source 104. The command transmitter 515 is configured to transmit commands that are recognized by the audiovisual content source 104.

In one embodiment, the presentation unit 522 may cause the command transmitter 515 to transmit commands 118 to the audiovisual content source 104 for pausing delivery of the audiovisual content stream while the additional information is presented to the user.

In another embodiment, the remote control 508 transmits the remote control commands 518 for the audiovisual content source 104 in a first format that is not recognized by the audiovisual content source. The command receiver 514 receives the remote control commands 518 in the first format. The command transmitter 515 then transmits the remote control commands received by the command receiver 514 in a second format 118 that is recognized by the audiovisual content source 104.

In another embodiment, the command transmitter 515 both transmits commands 118 for pausing delivery of the audiovisual content stream and retransmits received commands in a second format in the manner previously described.

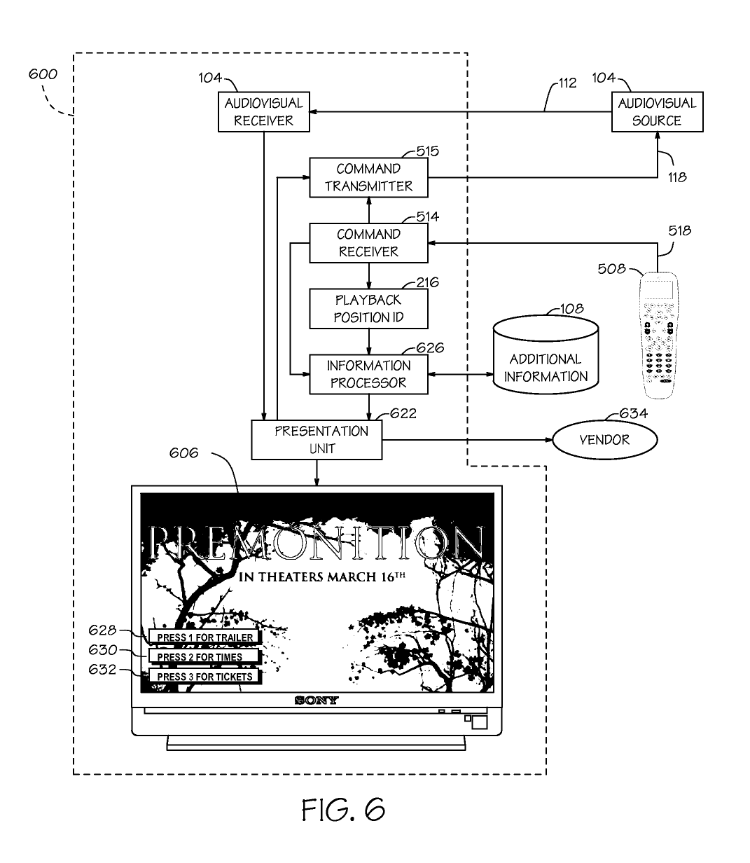

FIG. 6 shows a system that includes another audiovisual content display apparatus 600 that embodies the invention. An information processor 626 receives the estimates of the playback position from the playback position identifier 216. The information processor 626 may obtain additional information 108 related to the playback position within the audiovisual contents and provide it to the presentation unit 622 to be displayed to the user. The information processor 626 may also receive a program identification for the audiovisual contents and use that identification is obtaining the related additional information 108.

The information provided to the presentation unit 622 by the information processor 626 may include interactive features such as menu items 628, 630, 632. The information processor 626 may receive remote control commands 518 from the command receiver 514 to accept user input. The command receiver 514 may recognize remote control commands that are intended for the information processor 626 rather than the audiovisual content source 104 and route them accordingly. The user input may, for example, allow a selection of a menu item 628, 630, 632. The information processor 626 may obtain further additional information 108 based on the user input and provide it to the presentation unit 622 to be displayed to the user.

The additional information 108 may include ordering information and a link to a vendor 634. The link may be an address on a network, such as a universal resource locator (URL) for the internet. The information processor 626 may present the ordering information to the user using the presentation unit 622, receive an order from the user using the command receiver 514, and transmit the order to the vendor using the link.

For example, the information processor 626 may determine that the playback position is at a commercial message for a movie. The additional information 108 for that commercial message may indicate that a trailer, local show times, and ticket ordering are available for the advertised movie. The information processor 626 may cause menu items 628, 630, 632 for those pieces of additional information to be presented to the user as links to the additional information. Using the received remote control commands, the information processor 626 may provide navigation to a link and receive a selection of the link from the user. The information processor 626 may then present additional information to the user in response to the selection of the link, such displaying the trailer, displaying local show times, or presenting an interactive ticket ordering screen. The information processor 626 may use other information such as geographic location of the audiovisual content display apparatus 600 or the user's payment information when processing these types of additional information.

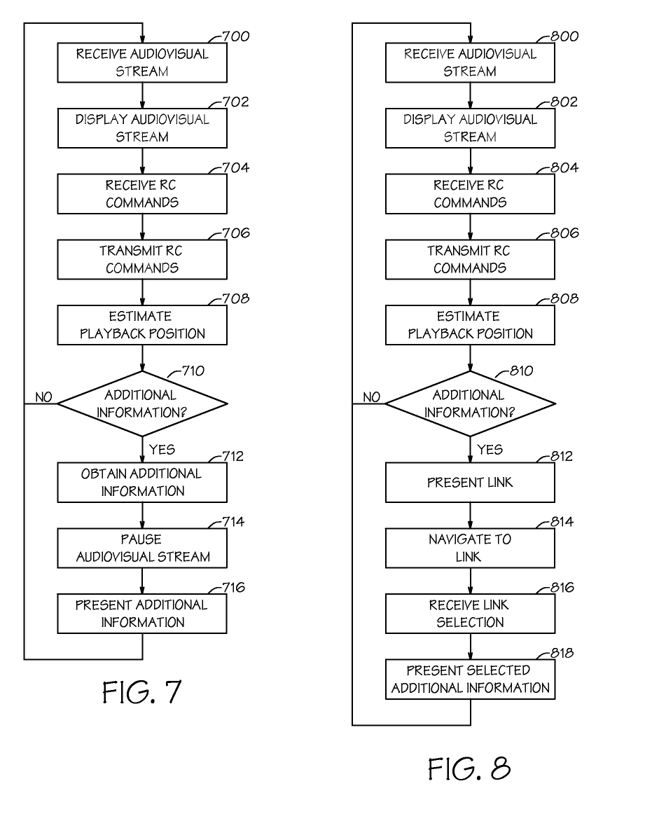

FIG. 7 is a flowchart for a method of providing information related to an audiovisual content stream that embodies the invention. The audiovisual content stream is received from an audiovisual content source 700 and displayed to a user on an audiovisual content display 702. Remote control (RC) commands directed to the audiovisual content source are received 704. In one embodiment the remote control commands for the audiovisual content source are received in a first format that is not recognized by the audiovisual content source and the received remote control commands are transmitted in a second format that is recognized by the audiovisual content source 706.

A playback position within the audiovisual content stream is estimated by analyzing the remote control commands for the audiovisual content source 708. It is determined if there is additional information related to the playback position within the audiovisual contents 710. If there is no additional information related to the current playback position 710-NO, the method continues to receive the audiovisual content stream and check for additional information at successive playback positions.

If there is additional information 710-YES, the additional information is obtained 712 and presented to the user 716. Remote control commands may be transmitted to the audiovisual content source for pausing delivery of the audiovisual content stream while the additional information is presented to the user 712. The additional information may be presented to the user as a picture-in-picture display, a picture outside picture (POP) display, or an audiovisual content overlay over the audiovisual content or it may replace the display of the audiovisual content. After the additional information has been presented to the user 714, additional audiovisual content may be received 700. Or the audiovisual content may continue to be received without interruption while the additional information is presented to the user.

FIG. 8 is a flowchart for another method of providing information related to an audiovisual content stream that embodies the invention. The audiovisual content stream is received 800 and displayed to a user 802. Remote control commands are received 804 and possibly transmitted to the audiovisual content source in a different format 806. A playback position is estimated by analyzing the remote control commands 808. It is determined if there is additional information related to the playback position within the audiovisual contents 810. If there is no additional information related to the current playback position 810-NO, the method continues to receive the audiovisual content stream and check for additional information at successive playback positions.

If there is additional information 810-YES, the additional information may be in the form of one or more links. The one or more links may be presented to the user 812. Navigation to the link responsive to inputs received from the user may be provided 814. A selection of a link may be received from the user 816. Presentation of the additional information to the user may be responsive to the selection of the link 818. After the additional information has been presented to the user 818, additional audiovisual content may be received 800. Or the audiovisual content may continue to be received without interruption while the additional information is presented to the user.

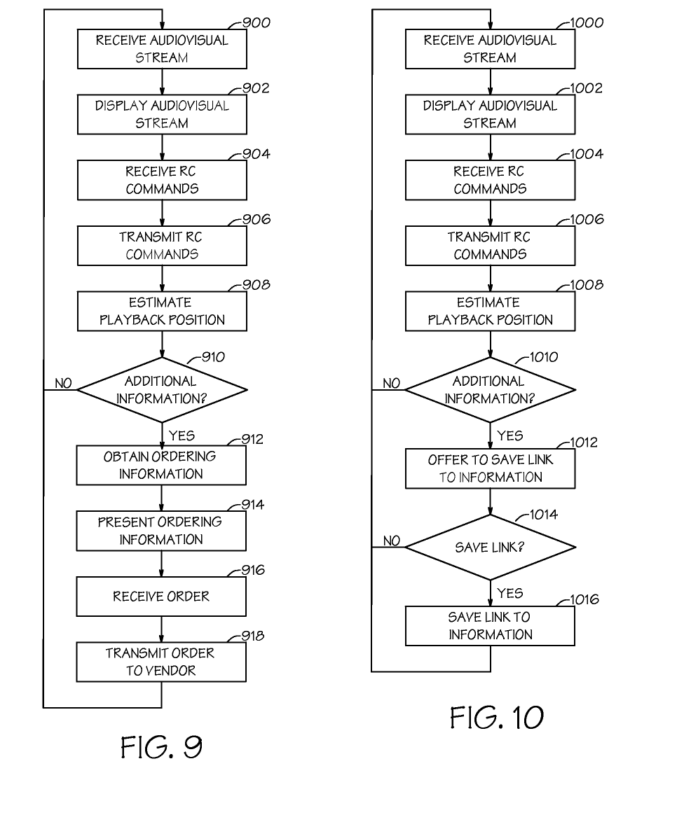

FIG. 9 is a flowchart for another method of providing information related to an audiovisual content stream that embodies the invention. The audiovisual content stream is received 900 and displayed to a user 902. Remote control commands are received 904 and possibly transmitted to the audiovisual content source in a different format 906. A playback position is estimated by analyzing the remote control commands 908. It is determined if there is additional information related to the playback position within the audiovisual contents 910. If there is no additional information related to the current playback position 910-NO, the method continues to receive the audiovisual content stream and check for additional information at successive playback positions.

If there is additional information 910-YES, the additional information may be in the form of ordering information to purchase goods or services, make reservations for dining, make travel arrangements, and the like. The ordering information is obtained 912 and presented to the user 914. An order may be received from the user 916. The order may be transmitted to a vendor using a link to the vendor provided with the additional information 918. Additional personal information for processing the order may be transmitted to the vendor. After transmitting the order 918, additional audiovisual content may be received 900. Or the audiovisual content may continue to be received without interruption while the additional ordering information is presented and processed.

FIG. 10 is a flowchart for another method of providing information related to an audiovisual content stream that embodies the invention. The audiovisual content stream is received 1000 and displayed to a user 1002. Remote control commands are received 1004 and possibly transmitted to the audiovisual content source in a different format 1006. A playback position is estimated by analyzing the remote control commands 1008. It is determined if there is additional information related to the playback position within the audiovisual contents 1010. If there is no additional information related to the current playback position 1010-NO, the method continues to receive the audiovisual content stream and check for additional information at successive playback positions.

If there is additional information 1010-YES, an offer to save a link to the additional information may be presented to the user 1012. If the user selects the option to save the link 1014-YES, the link to the additional information is saved for later use by the user 1016. In another embodiment, all links to additional information presented to the user may be saved for later viewing. Playback by the source of the audiovisual content may continue while the offer to save the link is presented to the user 1012. Offering to save a link may be done as an alternative to pausing the display of the audiovisual content or when the audiovisual content cannot be paused. Saved links may be kept until deleted or they may be deleted automatically after being viewed or after some time has elapsed since they were saved.

The invention described herein may be embodied in specific hardware components that contain hardwired logic for performing the operations. Alternatively, program instructions may be used to cause a functional change in a general-purpose or special-purpose processing system that is programmed with the instructions, or any combination of programmed computer components and custom hardware components, to perform functions that embody the invention.

The invention described herein may be embodied in an article of manufacture that provides information in a form readable by a computer. The term “computer” as used in this description is intended to include any device or machine whose function can be altered by the receipt of information. Computers include, but are not limited to, central processing units, processors, controllers, and programmable arrays. When read by a computer, the information provided by the article of manufacture causes a functional change in the computer such that the computer performs functions and produces tangible results as determined by the information. The article of manufacture or the information it provides may be referred to as software, firmware, program, procedure, process, application, logic, and so on. Software, or any equivalent term, may be said to perform a function or produce a result meaning that when a computer reads the information that represents the software, the functional change in the computer causes the computer to perform a function or produce a result.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. An audiovisual content display apparatus comprising:
an audiovisual content receiver that receives an audiovisual content stream from an audiovisual content source;
an audiovisual content display that displays the audiovisual content stream to a user;
a command receiver that receives remote control commands directed to the audiovisual content source;
a playback position identifier to estimate a playback position in the audiovisual content stream by analyzing the remote control commands for the audiovisual content source; and
a presentation unit that presents additional information related to the playback position to the user.

2. The apparatus of claim 1 further comprising a command transmitter that transmits commands to the audiovisual content source for pausing delivery of the audiovisual content stream while the additional information is presented to the user.

3. The apparatus of claim 1, wherein the command receiver receives the remote control commands for the audiovisual content source in a first format that is not recognized by the audiovisual content source, the apparatus further comprising a command transmitter that transmits the received remote control commands in a second format that is recognized by the audiovisual content source.

4. The apparatus of claim 1 further comprising an information processor that obtains the additional information related to the playback position within the audiovisual contents and provides it to the presentation unit.

5. The apparatus of claim 4, wherein the information processor further:
obtains a link to the additional information;
causes the link for the additional information to be presented to the user;
provides navigation to the link responsive to inputs received from the user;
receives a selection of the link from the user; and
presents the additional information to the user in response to the selection of the link.

6. The apparatus of claim 4, wherein the additional information includes ordering information and a link to a vendor, the information processor further:
presents the ordering information to the user;
receives an order from the user; and
transmits the order to the vendor using the link.

7. The apparatus of claim 1, wherein the additional information is presented to the user on the audiovisual content display as one of a picture-in-picture (PIP) display, a picture outside picture (POP) display, and an audiovisual content overlay.

8. The apparatus of claim 1, wherein the additional information is stored for presentation to the user at a later time.

9. A method of providing information related to an audiovisual content stream, the method comprising:
receiving an audiovisual content stream from an audiovisual content source;
displaying the audiovisual content stream to a user on an audiovisual content display;
receiving remote control commands directed to the audiovisual content source;
estimating a playback position in the audiovisual content stream by analyzing the remote control commands for the audiovisual content source; and
presenting additional information related to the playback position to the user.

10. The method of claim 9, wherein the remote control commands for the audiovisual content source are received in a first format that is not recognized by the audiovisual content source, the method further comprising transmitting the received remote control commands in a second format that is recognized by the audiovisual content source.

11. The method of claim 10 further comprising transmitting commands to the audiovisual content source for pausing delivery of the audiovisual content stream while the additional information is presented to the user.

12. The method of claim 9 further comprising:
determining if there is additional information related to the playback position; and
if there is additional information related to the playback position, obtaining the additional information related to the playback position for presentation to the user.

13. The method of claim 12 further comprising:
obtaining a link to the additional information;
presenting the link for the additional information to the user;
navigating to the link responsive to inputs received from the user;
receiving a selection of the link from the user; and
presenting the additional information to the user in response to the selection of the link.

14. The method of claim 9, wherein the additional information includes ordering information and a link to a vendor, the method further comprising:
presenting the ordering information to the user;
receiving an order from the user; and
transmitting the order to the vendor using the link.

15. The method of claim 9 further comprising presenting the additional information is to the user on the audiovisual content display as one of a picture-in-picture (PIP) display, a picture outside picture (POP) display, and an audiovisual content overlay.

16. The method of claim 9 further comprising storing the additional information for presentation to the user at a later time.

17. An audiovisual content display apparatus comprising:
means for receiving an audiovisual content stream from an audiovisual content source;
means for displaying the audiovisual content stream to a user on an audiovisual content display;
means for receiving remote control commands directed to the audiovisual content source;
means for estimating a playback position in the audiovisual content stream by analyzing the remote control commands for the audiovisual content source; and
means for presenting additional information related to the playback position to the user.

18. The apparatus of claim 17, wherein the remote control commands for the audiovisual content source are received in a first format that is not recognized by the audiovisual content source, the apparatus further comprising means for transmitting the received remote control commands in a second format that is recognized by the audiovisual content source.

19. The apparatus of claim 18 further comprising means for transmitting commands to the audiovisual content source for pausing delivery of the audiovisual content stream while the additional information is presented to the user.

20. The apparatus of claim 17 further comprising:
means for determining if there is additional information related to the playback position; and
means for obtaining the additional information related to the playback position for presentation to the user if there is additional information related to the playback position.

21. The apparatus of claim 20 further comprising:
means for obtaining a link to the additional information;
means for presenting the link for the additional information to the user;
means for navigating to the link responsive to inputs received from the user;
means for receiving a selection of the link from the user; and
means for presenting the additional information to the user in response to the selection of the link.

22. The apparatus of claim 17, wherein the additional information includes ordering information and a link to a vendor, the apparatus further comprising:
means for presenting the ordering information to the user;
means for receiving an order from the user; and
means for transmitting the order to the vendor using the link.

23. The apparatus of claim 17 further comprising means for presenting the additional information is to the user on the audiovisual content display as one of a picture-in-picture (PIP) display, a picture outside picture (POP) display, and an audiovisual content overlay.

24. The apparatus of claim 17 further comprising means for storing the additional information for presentation to the user at a later time.
